(19) United States
(12) Patent Application Publication
(10) Pub. No.: US 2013/0070928 A1
(43) Pub. Date: Mar. 21, 2013

(54) METHODS, SYSTEMS, AND MEDIA FOR MOBILE AUDIO EVENT RECOGNITION

(71) Applicants: Daniel P. W. Ellis, New York, NY (US); Courtenay V. Cotton, New York, NY (US); Tom Friedland, Austin, TX (US); Kris Esterson, Jacksonville, FL (US)

(72) Inventors: Daniel P. W. Ellis, New York, NY (US); Courtenay V. Cotton, New York, NY (US); Tom Friedland, Austin, TX (US); Kris Esterson, Jacksonville, FL (US)

(21) Appl. No.: 13/624,532

(22) Filed: Sep. 21, 2012

Related U.S. Application Data
(60) Provisional application No. 61/537,550, filed on Sep. 21, 2011.

(51) Int. Cl. H04R 29/00

(52) U.S. Cl. 381/56

(57) ABSTRACT

Methods, systems, and media for mobile audio event recognition are provided. In some embodiments, a method for recognizing audio events is provided, the method comprising: receiving an application that includes a plurality of classification models from a server, wherein each of the plurality of classification models is trained to identify one of a plurality of classes of non-speech audio events; receiving an audio signal; storing at least a portion of the audio signal; extracting, a plurality of audio features from the portion of the audio signal based on one or more criterion; comparing each of the plurality of extracted audio features with the plurality of classification models; identifying at least one class of non-speech audio events present in the portion of the audio signal based on the comparison; and providing an alert corresponding to the at least one class of identified non-speech audio events.

### CROSS-REFERENCE TO RELATED APPLICATIONS

This application claims the benefit of U.S. Provisional Patent Application No. 61/537,550, filed Sep. 21, 2011, which is hereby incorporated by reference herein in its entirety.

### TECHNICAL FIELD

The disclosed subject matter relates to methods, systems, and media for mobile audio event recognition.

### BACKGROUND

For the deaf and hearing impaired, the lack of awareness of ambient sounds can produce stress as well as reduce independence. More particularly, the inability to identify, for example, the sounds of a fire alarm, a door knock, a horn honk, a baby crying, or footsteps approaching can be difficult, stressful, and, in many cases, dangerous.

Various approaches attempt to address these problems by providing a user-controlled threshold on the ambient audio level and alerting the user when this threshold is exceeded. However, the sensitivity of this threshold makes it impractical in many situations. A typical result is that the user is alerted constantly in response to any insignificant sound. On the other hand, when the threshold is adjusted to prevent the generation of constant alerts, the approach becomes insensitive to even significant audio events. Moreover, these approaches provide an alert and make no attempt to recognize or classify the event that caused the alert.

There is therefore a need in the art for approaches for recognizing audio events and, in particular, for recognizing non-speech audio events and providing one or more alerts to deaf or hearing impaired individuals of these events. Accordingly, it is desirable to provide methods, systems, and media that overcome these and other deficiencies of the prior art.

### SUMMARY

In accordance with various embodiments of the disclosed subject matter, methods, systems, and media for mobile audio event recognition are provided.

In accordance with some embodiments, a method for recognizing audio events is provided, the method comprising: receiving, using a hardware processor in a mobile device, an application that includes a plurality of classification models from a server, wherein each of the plurality of classification models is trained to identify one of a plurality of classes of non-speech audio events; receiving, using the hardware processor, an audio signal; storing, using the hardware processor, at least a portion of the audio signal; extracting, using the hardware processor, a plurality of audio features from the portion of the audio signal based on one or more criterion; comparing, using the hardware processor, each of the plurality of extracted audio features with the plurality of classification models; identifying, using the hardware processor, at least one class of non-speech audio events present in the portion of the audio signal based on the comparison; and providing, using the hardware processor, an alert corresponding to the at least one class of identified non-speech audio events.

In accordance with some embodiments, a systems for recognizing audio events is provided, the system comprising: a processor of a mobile device that: receives, using a hardware processor in a mobile device, an application that includes a plurality of classification models from a server, wherein each of the plurality of classification models is trained to identify one of a plurality of classes of non-speech audio events; receives, using the hardware processor, an audio signal; stores, using the hardware processor, at least a portion of the audio signal; extracts, using the hardware processor, a plurality of audio features from the portion of the audio signal based on one or more criterion; compares, using the hardware processor, each of the plurality of extracted audio features with the plurality of classification models; identifies, using the hardware processor, at least one class of non-speech audio events present in the portion of the audio signal based on the comparison; and provides, using the hardware processor, an alert corresponding to the at least one class of identified non-speech audio events.

In accordance with some embodiments, a non-transitory computer-readable medium containing computer-executable instructions that, when executed by a processor, cause the processor to perform a method for recognizing audio events, the method comprising: receiving an application that includes a plurality of classification models from a server, wherein each of the plurality of classification models is trained to identify one of a plurality of classes of non-speech audio events; receiving an audio signal; storing at least a portion of the audio signal; extracting a plurality of audio features from the portion of the audio signal based on one or more criterion; comparing each of the plurality of extracted audio features with the plurality of classification models; identifying at least one class of non-speech audio events present in the portion of the audio signal based on the comparison; and providing an alert corresponding to the at least one class of identified non-speech audio events.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative process for mobile audio event recognition in accordance with some embodiments of the disclosed subject matter;

FIG. 2 shows an illustrative process for providing an alert to a user in accordance with some embodiments of the disclosed subject matter;

FIG. 3 shows an illustrative process for mobile event recognition using a threshold in accordance with some embodiments of the disclosed subject matter;

FIG. 4 shows an illustrative process for mobile event recognition that includes contacting emergency services in accordance with some embodiments of the disclosed subject matter;

FIG. 5A shows a schematic diagram of an illustrative system suitable for implementation of an application for mobile event recognition in accordance with some embodiments of the disclosed subject matter;

FIG. 5B shows a detailed example of the server and one of the mobile devices of FIG. 5A that can be used in accordance with some embodiments of the disclosed subject matter;

FIG. 6 shows a diagram illustrating a data flow used in the process of FIGS. 1, 3 or 4 in accordance with some embodiments of the disclosed subject matter;

FIG. 7 shows another diagram illustrating a data flow used in the process of FIG. 1, 3, or 4 in accordance with some embodiments of the disclosed subject matter; and

FIG. 8 shows another diagram illustrating, a data flow used in the process of FIGS. 1, 3, or 4 in accordance with some embodiments of the disclosed subject matter.

### DETAILED DESCRIPTION

In accordance with various embodiments, mechanisms for mobile audio event recognition are provided. These mechanisms can include identifying non-speech audio events (also referred to herein as “events” or “audio events”), such as the sound of an emergency alarm (e.g., a fire alarm, a carbon monoxide alarm, a tornado warning, etc.), a door knock, a door bell, an alarm clock, a baby crying, a telephone ringing, a car horn honking, a microwave beeping, water running, a tea kettle whistling, a dog barking, etc. This can further include detecting individual audio events (e.g., a bell ring), classifying the acoustic environment (e.g., outdoors, indoors, noisy environment, etc.), and/or distinguishing between types of sounds (e.g., speech and music).

In some embodiments, these mechanisms can identify non-speech audio events by receiving an audio input from a microphone or any other suitable audio input, extracting audio features from the audio input, and comparing the extracted audio features with one or more classification models to identify a non-speech audio event. Additionally or alternatively, these mechanisms can analyze transient audio events in an audio signal, which can decrease the number of background audio events that are incorrectly identified as a recognized non-speech audio event, thereby reducing the number of false positives. It should be noted that one or more of mel-frequency cepstral coefficients (MFCCs), non-negative matrix factorization (NMF), hidden Markov models (HMMs), support vector machines (SVMs), or any suitable combination thereof can be used to identify non-speech audio events.

In some embodiments, each of the classification models used to identify events can be trained to recognize one or more events, where each type of event can be referred to as a class that the classification model is trained to recognize. In some embodiments, one or more classification models can be combined to form an event detector that can detect a discrete set of events. For example, an event detector can recognize a discrete set of five or ten classes of events, where the event detector can be a combination of classification models. Additionally or alternatively, a user can select particular events for an event detector to identify from a closed set of classes. For example, if an event detector is made up of classification models trained to recognize ten classes of events, the user can select a subset of those ten classes for the event detector to recognize. This can allow a user to customize the event detector to suit his or her particular wishes.

In some embodiments, a classification model can be updated to more accurately recognize events, and/or trained to recognize new events. For example, if a classification model is trained to recognize a fire alarm class, but fails to recognize a particular type of fire alarm, it can be trained to incorporate the particular type of fire alarm into the fire alarm class. As another example, the classification model can be trained to recognize new events. For example, if a user has a distinctive doorbell (such as a doorbell that plays a song), a classification model can be trained to recognize the user's doorbell as a new class, for example, “my doorbell,” and/or can update the existing doorbell classification model with the user's doorbell. The classification model can identify the user's doorbell and alert the user to the fact that the doorbell has sounded based on the new and/or updated doorbell class.

In some embodiments, the identification of one or more non-speech audio events can be used as training data to update the one or more classification models. For example, as audio inputs and extracted audio features are analyzed by a mobile device, the recognized non-speech audio events can be provided as feedback to train, update, and/or revise one or more classification models used by these mechanisms. As another example, if a user identifies a particular event as belonging to a particular class, the identification and an audio file containing the identified event can be sent to a server. In such an example, the audio file can be used to train, update, and/or revise one or more classification models to incorporate the event identified by the user. This can allow previously unidentified sounds to be incorporated into an updated event detector. Such an updated event detector can be periodically sent to one or mobile devices using these mechanisms in order to more accurately alert users to previously unidentified audio events.

In some embodiments, in response to a non-speech audio event being identified, an alert can be generated to alert a user of the mechanisms to a corresponding non-speech audio event. For example, in response to identifying a door knock sound, the user can be alerted with a vibrotactile signal, a vibrational alert from a mobile device, and/or a visual alert on the screen of the mobile device to inform the user that a door knock sound has been detected. Additionally or alternatively, alerts can be provided based on the type or severity of the detected non-speech audio event. For example, in response to detecting a fire alarm, a visual alert and a vibrational alert can be generated at a mobile device associated with the user and a communication can be transmitted to an emergency service provider (e.g., the fire department, a 911 operator, etc.) or any other suitable emergency contact, such as a family member. In a more particular example, if an alert is generated in response to, for example, a fire alarm and the user does not acknowledge the alert on the mobile device within a predefined period of time (e.g., ten seconds, thirty seconds, etc.), an emergency service provider can be contacted.

In some embodiments, the visual alert can provide the user with the opportunity to select from one or more options that likely identify the non-speech audio event. For example, the user can determine which of the provided non-speech audio events has a higher likelihood based on environment, past experience, and/or other factors.

In some embodiments, the mechanisms described herein can be used to find the source of an ongoing audio event. For example, an audio event recognition application installed on a mobile device utilizing the mechanisms described herein can use a microphone, an accelerometer, a camera, a position detector, and/or any other suitable component of the mobile device to locate the source of a detected audio event. More particularly, if a classification model recognizes an audio event as matching, for example, running water, the user can choose an option to track that audio event. In such an example, the program can measure the amplitude of the tracked audio event as the user moves around (which can be detected, for example, using accelerometers, the output of a camera, the output of a position detector, etc.) and inform the user of whether the audio event is getting louder or softer (e.g., louder indicating that the user is getting closer, or softer indicating that the user is getting farther from the source of the audio event).

In another example, an audio event recognition application installed in a vehicle utilizing the mechanisms described herein can use a microphone, a position detector, and/or other instruments installed in or connected to the vehicle to inform a user of the vehicle whether a sound is coming toward the user or moving away from the user. More particularly, if a classification model recognizes an audio event as matching, for example, an emergency siren, the user can be informed of whether the source of the audio event is moving, closer or farther from the vehicle. In such an example, the program can use changes in amplitude and/or frequency (e.g., Doppler shift) to determine whether the source of the audio event is moving closer or farther from the vehicle.

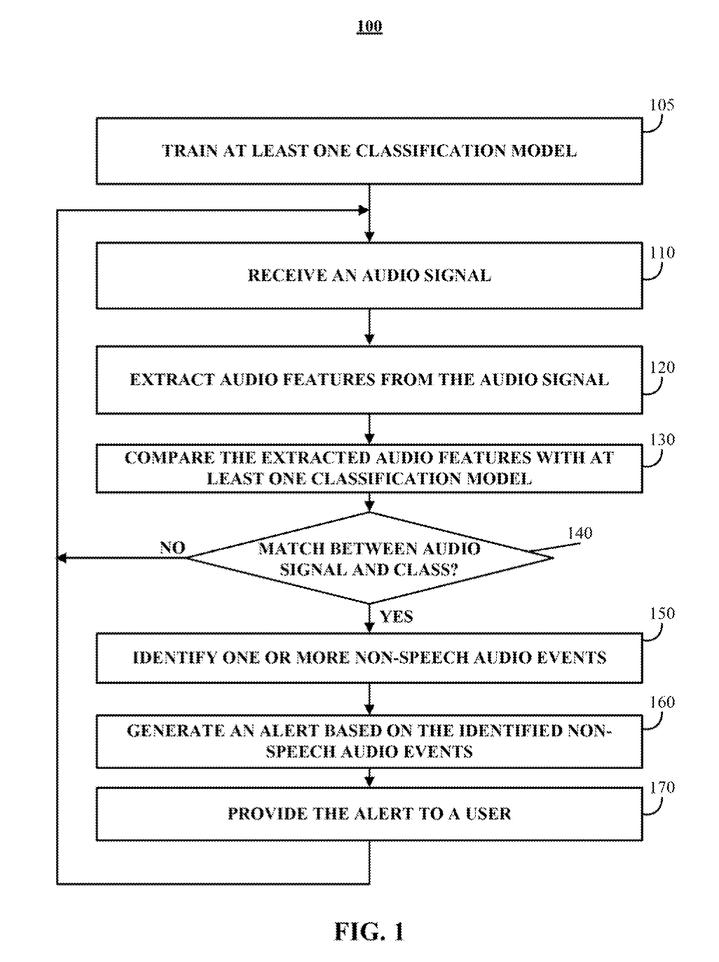

Turning to FIG. 1, an example of a process 100 for mobile audio event recognition using an application using the mechanisms described herein is illustrated in accordance with some embodiments.

Process 100 can start by training at least one classification model at 105. For example, a classification model can be trained using audio signals, where audio events in the audio signal are labeled as belonging to a specific class (collectively referred to herein as a training dataset). The one or more classification models can use this training dataset to generate one or more representative event-like audio clips of how each audio event sounds. After the one or more classification models have been trained the one or more classification models can be used to identify audio events in unlabeled audio signals. As an example, a set of known sounds, such as the FBK-Irst database, can be used to train a classification model. In another example, sounds captured and labeled using a mobile device can be compiled into a database to be used in training a classification model. More particularly, the application can be used to label previously unidentified and/or incorrectly classified audio events. These labeled audio events can be transmitted to, for example, a server. The server can use audio events submitted using the application to train, update, and/or revise one or more classification models, and transmit the new, updated, and/or revised classification models to a plurality of mobile devices that installed with the application, that may or may not include the mobile device running the application that submitted the previously unidentified audio event(s).

In some embodiments, the classification model can be based on a hidden Markov model. Additionally or alternatively, the classification model can be based on support vector machine. The hidden Markov model and/or support vector machine can be trained using the training dataset.

At 110, an audio signal can be received by the application running on a mobile device. In some embodiments, the audio signal can be received from a microphone of the mobile device. For example, the audio signal can be received from a built-in microphone of a mobile phone or smartphone capturing ambient sound. As another example, the audio signal can be received from a built-in microphone of a tablet computer. As yet another example, the audio signal can be received from a microphone of a special purpose device built for the purpose of recognizing non-speech audio events.

Additionally or alternatively, the audio signal can be received from any microphone capable of outputting an audio signal to the mobile device. For example, the audio signal can be received from a microphone carried by a user or coupled to the body of a user in any suitable manner, and connected to the mobile device by a wire or wirelessly. As another example, the audio signal can be received from a microphone coupled to any suitable platform, such as an automobile, a bicycle, a scooter, a wheelchair, a purse or bag, etc., and coupled to the mobile device by a wire or wirelessly.

At 120, the application can extract audio features from the audio signal received at 110. In some embodiments, mel-frequency cepstral coefficients can be used to extract audio features from the audio signal received at 110. For example, the audio signal can be segmented into 25 millisecond frames with 10 millisecond hops, where each frame contains 40 mel-frequency bands. In such an example, 25 coefficients can be retained as audio features. It should be noted that the specific frame lengths, hops, mel-frequency bands, and number of coefficients is intended to be illustrative and the disclosed subject matter is not limited to using these specific values, but instead can use any suitable values for finding the MFCCs of the audio signal.

As another example, a process based on non-negative matrix factorization (NMF) can be used to extract audio signals at 110. More particularly, the audio data can be downsampled to 12 kHz and a short-time Fourier transform (STFT) can be taken for a certain length audio signal (for example, 2.5 seconds, five seconds, ten seconds, etc.), using 32 millisecond frames and 1.6 millisecond hops. The frequency axis can be converted to the mel scale using 30 mel-frequency bands from 0 to 6 kHz. Spectrograms of all training data used to train one or more classification models can be concatenated and a convolutive NMF can be performed across the entire set of training data, using 20 basis patches which are each 32 frames wide. This can yield a set of basis patches W and a set of basis activations H to model 16 classes of acoustic events. A sliding one-second window with 250 millisecond hops can be used to represent the continuous activation patterns of the basis patches by taking the log of the maximum of each activation dimension, producing a set of 20 features per window.

In some embodiments, extraction of audio features can be performed by the application running on the mobile device. Additionally or alternatively, the audio received at 110 can be transmitted to a remote computing device (e.g., a server) and the extraction of audio features can be performed by the remote computing device.

At 130, the application can compare the audio features extracted at 120 with at least one classification model. In some embodiments, a hidden Markov model (HMM) can be used to compare the audio features extracted at 120 to the one or more classification models. For example, an HMM trained using a training dataset with audio features extracted from the training dataset using mel-frequency cepstral coefficients (MFCCs) can be used to determine whether audio features extracted at 120 belong to a class of audio features contained in the training dataset. Additionally or alternatively, a hidden Markov model trained using a training dataset with audio features extracted from the training dataset using the non-negative matrix factorization (NMF) based process described above can be used to determine whether audio features extracted at 120 belong to a class of audio features contained in the training dataset. in either case, the HMM can return the probability that a particular audio feature corresponds to a class in the training dataset. In some embodiments, a combination of data from an MFCC-based HMM and data from an NMF-based HMM can be combined to yield results with reduced error rates when the audio signal has a signal to noise ratio below a threshold.

In some embodiments, a support vector machine (SVM) can be used to compare the audio features extracted at 120 to the one or more classification models, For example, an SVM trained using a training dataset with audio features extracted from the training dataset using MFCC can be used to determine whether audio features extracted at 120 belong to a class of audio features contained in the training dataset. Additionally or alternatively, an SVM trained using a training dataset with audio features extracted from the training dataset using the non-negative matrix factorization (NMF) based process described above can be used to determine whether audio features extracted at 120 belong to a class of audio features contained in the training dataset. In either case, the SVM can return the probability that a particular audio feature corresponds to a class in the training dataset. In some embodiments, a combination of data from a MFCC-based SVM and data from a NMF-based SVM can be combined to yield results with reduced error rates when the audio signal has a signal to noise ratio below a certain ratio.

In some embodiments, comparing, the extracted audio features to at least one classification model can be performed by the application running on the mobile device. Additionally or alternatively, the audio received at 110 and/or the audio features extracted at 120 can be transmitted to a remote computing device (e.g., a server) and the comparison of the extracted audio features can be performed by the remote computing device.

In some embodiments, specific types of background noise can be taken into account when comparing one or more audio features. For example, the process can attempt to detect a specific background noise, such as, for example, street noise, people talking, etc. This detected background noise can be filtered using a filter provided for the specific type of background noise. In another example, low frequency audio can be filtered to attempt to mitigate some background noise. In yet another example, the audio signal can be normalized using an automatic gain control (AGC) process that can make different background environments more uniform (e.g., more smooth, with less sharp transitions, etc.).

At 140, the application can check the results of the comparisons at 130 to determine if there is any match between the extracted audio features from the audio signal and a class of the one or more classification models. In some embodiments, the application can determine whether the match between extracted audio features and a class is greater than a threshold probability (for example, 10%). If there is a match (“YES” at 140), process 100 can proceed to 150. Otherwise, if a match is not found (“NO” at 140), process 100 can return to 110 and continue to receive an audio signal.

At 150, the application can identify one or more non-speech audio events based on the comparison performed at 130 and the determination performed at 140. In some embodiments, non-speech audio events can be identified as belonging to one or more classes if they exceed some threshold probability that they match more than one of the one or more classes. For example, if a classification model determines that there is greater than a 50% chance that the event matches a particular class, the classification model can identify the event as matching that class. In some embodiments, the class that is determined by the one or more classification models to be the closest match to the event can be identified at 150. Additionally or alternatively, the one or more classification models can identify more than one of the likely classes and/or the probability that the event matches a particular class. For example, if the one or more classification models find that there is a 50% probability that an audio event is an emergency alarm, and that there is a 75% chance that the same audio event is an alarm clock, the classification models can identify the event as matching both an emergency alarm class and an alarm clock class.

In some embodiments, the threshold used for determining that an event matches a particular class can be determined by a user. For example, the user can set the threshold for a match at 75% (or any other suitable threshold level) so that the classification models identify an event as matching a class if the probability of a match is 75% or greater. Additionally or alternatively, a user can set the threshold using qualitative settings that correspond with a numeric threshold. For example, the user can be given a choice between three settings: aggressive, neutral, and conservative. In such an example, aggressive can correspond to a threshold of 50%, neutral can correspond to a threshold of 75%, and conservative can correspond to a threshold of 90%. As another example, the user can be given a choice to set the sensitivity at high, medium, or low. As yet another example, the user can set the sensitivity based on a scale of one to ten, or any other suitable method of setting the sensitivity. In such examples, the numerical threshold can optionally be displayed to the user along with the qualitative setting.

In some embodiments, the user can be inhibited from changing the threshold for one or more classes. For example, the user can be inhibited from changing, the threshold for an emergency alarms class. As another example, the user can be inhibited from changing the threshold for any and/or all classes. It should be noted that the thresholds described herein are intended to be illustrative and are not intended to limit the disclosed subject matter.

At 160, the application can generate an alert based on the identified non-speech audio events. For example, if the classification models identify an audio event as matching a door knock class, an alert can be generated that indicates that a door knock has been identified. In some embodiments, the form of the alert can be based on the class that the event matches most closely. For example, an alert for a match to a fire alarm class can include a vibration alert that continues until the mobile device receives an acknowledgement of the alert. As another example, an alert for a match to a door knock class can include an intermittent vibration alert that stops after a specified period of time or when the mobile device receives an acknowledgement of the alert. As described above, an alert can include a visual alert, which can take the form of, for example, a flashing display, a blinking light (e.g., a mobile phone equipped with a camera flash can cause the flash to activate), an animation, any other suitable visual alert, or any suitable combination thereof. For example, an alert for an emergency alarm class can include an animation of a rotating colored emergency light, such as the lights commonly identified with emergency vehicles. In another example, an alert for a door knock class can include an image of a door, or an animation of a hand or person knocking on the door.

In some embodiments, a user can customize alerts generated in response to matches for certain classes. As an example, in the case of a match for a telephone ringing class, the user can select from a text alert stating that a telephone is ringing, multiple different images of telephones, an animation of a ringing telephone, or any suitable combination thereof. Alerts for other classes can be customized similarly. In some embodiments, there can be a subset of all alerts that the user is inhibited from customizing. For example, a user can be inhibited from customizing an alert for an emergency alarm class.

In some embodiments, the time when the alert is generated can be attached to the alert, where the time can be either displayed with the alert, used by the mobile device, used when contacting an emergency contact, used for any other suitable purpose, or any suitable combination thereof. More particularly, the time attached to the alert can be a time kept by the mobile device, a time received from a base station, a time kept according to a time entered by a user, etc.

In some embodiments, the location when the alert was generated can be attached to the alert. For example, global positioning system (GPS) coordinates can be attached to the alert. In another example, an approximate location can be attached to the alert based on multilateration of electromagnetic signals.

At 170, the application can provide the alert generated at 160 to a user through a vibrotactile device, a vibration generating device, and/or a display. In some embodiments, the alert can be provided using a mobile computing device running the application executing the process 100 (e.g., a smartphone, a tablet computer, a specialty device, etc.) having a vibration generating device and a display. For example, the alert can be provided to the user by driving a vibration generating device of a smartphone and generating a visual alert on the display of the smartphone. In a more particular example, as described above, an alert corresponding to an emergency alarm can include continuous or intermittent vibration, and an animation of a rotating colored emergency light. Additionally or alternatively, an alert can be provided to a user through a vibrotactile device in communication with the mobile device executing process 100. More particularly, a vibrotactile device worn on the body of a person can be connected to a headphone jack of a smartphone executing process 100, and the smartphone can cause the vibrotactile device connected to the headphone jack to vibrate to provide an alert to a user. A vibrotactile device can also be connected wirelessly to a smartphone executing the process 100 and can otherwise operate in the same manner as a vibrotactile device connected to a smartphone by a wire.

In some embodiments, the alert can be provided to a user driving a vehicle running the application executing process 100. For example, a microphone can be provided on one or more places on the exterior of a vehicle to capture audio of the environment surrounding the vehicle, and the vehicle can execute process 100 to recognize non-speech audio events outside the vehicle, such as, emergency vehicle sirens, vehicle horn honking, motorcycle engines, etc. In such an example, an alert can be provided to the driver of the vehicle through a vibrotactile device connected to the vehicle by wire or wirelessly, by vibration of the driver's seat, vibration of a steering wheel or other steering device (e.g., handle bars, a yoke, a joystick, etc.), and/or a visual display. A visual display in a vehicle can be provided, for example, in a console, in a rear-view mirror, as a heads up display (HUD) on the vehicle's windshield, on a display on a visor of glasses or a helmet visor worn by the driver, etc. Additionally or alternatively, a direction where an event originated can be determined based on the relative amplitude of the event at microphones placed at different positions on a vehicle, such as on the front and rear of the vehicle, and the direction where the event originated can be provided with the corresponding alert.

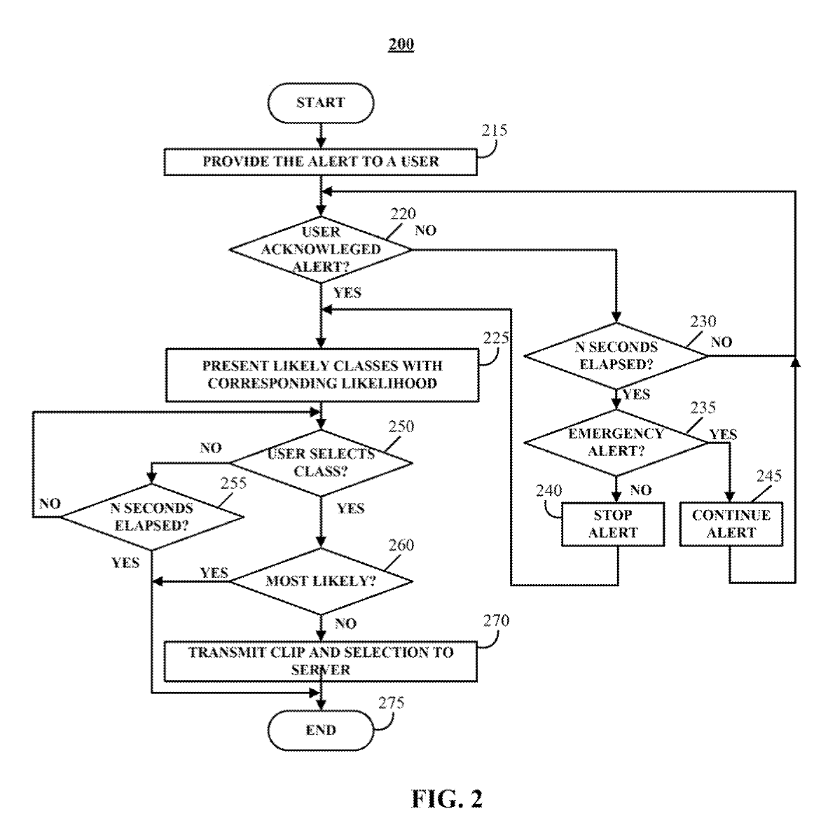

Turning to FIG. 2, an example of a process 200 for providing an alert to a user at 170 is illustrated in accordance with some embodiments. After process 200 is initiated, an alert can be provided to a user in the form of a vibrotactile signal, a vibration, a visual display, etc., at 215. Any suitable mechanism can be used to provide alerts, including those described herein.

At 220, the application can determine whether a user acknowledged the alert provided at 215. In some embodiments, an acknowledgment can take the form of pressing a button pressing, a series of button pressings, a portion of a touch screen, saying a particular word or combination of words, or any other suitable manner of acknowledging an alert. If the application determines that the user has acknowledged the alert (“YES” at 220), process 200 can proceed to 225. Otherwise, if the application determines that the user has not acknowledged the alert (“NO” at 220), process 200 can proceed to 230.

If the user has not acknowledged the alert at 220 and the process proceeded to 230, the application can determine whether a predetermined amount of time has elapsed since the alert was generated (e.g., n seconds, where n can be 0.5, 1, 2, etc.). If the application determines that the predetermined amount of time has not elapsed (“NO” at 230), the process can return to 220 and determine whether a user has acknowledged the alert. If it is determined at 230 that the predetermined amount of time has elapsed (“YES” at 230), the process can proceed to 235.

At 235, the application can determine whether the alert provided at 215 is an emergency alert (e.g., fire alarm, smoke alarm, carbon monoxide detector, emergency vehicle siren, etc.) can be determined. If the application determines that the alert provided at 215 is an emergency alert (“YES” at 235), the alert can be continued at 245 until the application receives an acknowledgment of the alert at 220. Otherwise, if the application determines that the alert provided at 215 is not an emergency alert (“NO” at 235), the application can stop the alert at 240 if it was determined at 230 that the predetermined amount of time has elapsed, and process 200 can proceed to 225.

In some embodiments, a list of a group of the likely classes that the audio event identified at 150 in process 100 belongs to can be provided with the alert generated at 160. For example, the two or three closest matching classes can be provided with the alert. In such an embodiment, if an emergency alert is contained on the list, the alert can be provided until the application receives an acknowledgment of the alert at 220. Additionally or alternatively, if the that application determines that the likelihood of the alert being an emergency alert is above a given threshold (e.g., 50% probability), the alert can be continued until the application receives an acknowledgment of the alert at 220, regardless of whether the emergency alert is the closest matching class for the audio event.

At 225, the application can present a user with a list of likely classes that the non-speech audio event belongs to. For example, for an alert generated for a particular audio event, the user can be presented with the two or three (or more) classes that most closely match the audio event. In a more particular example, for a particular audio event, the application can present audio classes for an alarm clock, a fire alarm, and a tea kettle whistle. Additionally, the application can present a choice for none of the presented classes (e.g., when the user believes that none of the presented classes correspond with the particular audio event).

In some embodiments, the probability or any other suitable score of the particular audio event belonging to each class can be presented along with the class. In the example described above, the user can be presented with a list including: an alarm clock (95%), a fire alarm (65%), and a tea kettle whistle (50%).

At 250, the application can determine whether the user has selected one of the classes from the list presented at 225 (including a user selection of none of the presented classes). If the application determines that the user has not selected a class (“NO” at 250), process 200 can proceed to 255 to determine whether a predetermined time has elapsed since the list was presented to the user at 225 (e.g., n seconds, where n can be 0.5, 1, 2, etc.). This predetermined time period can be the same period of time as in 230, or a different period of time. In some embodiments, a user can change the length of predetermined time in a settings interface, or choose to not show the list of the most likely classes when an alert is provided.

If the application determines at 255 that the predetermined time has not elapsed (“NO” at 255), process 200 can return to 250 to determine if the user chose an event. If instead the application determines that the predetermined time has elapsed (“YES” at 255), process 200 can proceed to 275 where the process is ended.

If the application determines at 250 that the user did choose a class (“YES” at 250), process 200 can proceed to 260 where it can be determined whether the class chosen by the user corresponds to the class with the highest probability (in the example discussed above, alarm clock has the highest probability). If the application determines at 260 that the class chosen by the user at 250 is the class with the highest probability (“YES” at 260), process 200 can proceed to 275 where the process is ended. Otherwise, if the application determines at 260 that the class chosen by the user at 250 is not the class with the highest probability (“NO” at 260), process 200 can proceed to 270 where the application can cause an audio clip and/or audio features extracted at 120 to be transmitted to a server along with the choice made by the user, the list of probable classes and the calculated probability that the audio event belonged to each class. in some embodiments, the information transmitted to the server at 270 can be used to train and/or update a classification model, where the information on the class of the audio event chosen by the user can be used in association with probabilities when training or updating the model. After transmitting the audio event and the user's choice to the server at 270, process 200 can proceed to 275 where the process ends. In some embodiments, the newly trained and/or updated classification model can be periodically sent to mobile devices running the application to provide an updated application that can recognize non-speech audio events more accurately, and/or recognize a greater number of non-speech audio events.

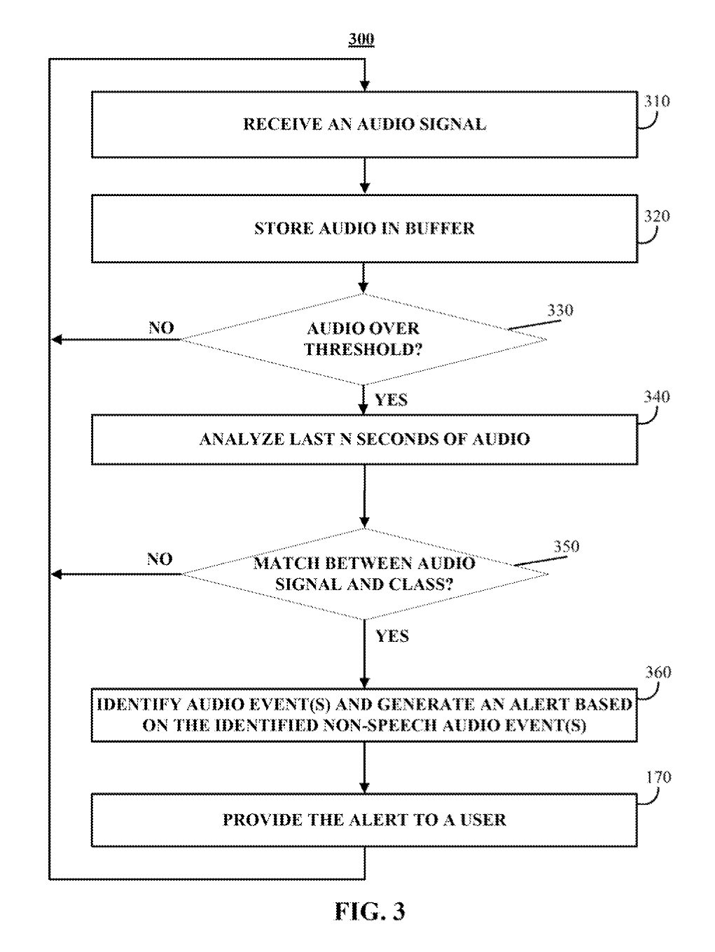

FIG. 3 shows an example of a process 300 for audio event recognition in accordance with some embodiments. Process 300 can start by receiving an audio signal at 310, which can be done in a similar manner as described with reference to 110 in FIG. 1. At 320, the audio signal received at 110 can be stored in a buffer that stores a predetermined amount of an audio signal (e.g., ten seconds, a minute, etc.). For example, the buffer can be a circular buffer where the signal captured on the buffer can be overwritten as new audio is captured where the oldest audio can be overwritten with new audio. As another example, the buffer can be implemented in memory (e.g., RAM, flash, hard drive, a partition thereof, etc.), and a controller (e.g.., any suitable processor) can control the reading and writing of the memory to store a certain amount of audio, where the most recent n seconds of audio can be made available.

At 330, the application can determine whether the audio stored in the buffer at 320 is over a threshold, where the threshold can be an amplitude threshold, a frequency threshold, a quality threshold, a matching threshold, any other suitable threshold, or any suitable combination thereof. As an example, the amplitude (e.g., the energy of the audio received at 110) of the audio being stored in the buffer can be calculated, and it can be determined if the amplitude of the audio is over a threshold (e.g., 40 dB, 65 dB, etc.). As another example, the frequency or quality of the audio being stored in the buffer can be calculated, and it can be determined if the frequency or quality is over a threshold. In such an example, some pre-processing can be performed on the audio signal to separate the audio signal into frequency bins and the presence of an audio signal at certain frequencies associated with the classes detected by the classification models can indicate that the audio is over a frequency threshold. Additionally or alternatively, the quality of the audio signal (e.g., how much noise is in the audio signal, or how pure the audio is) in certain frequency bands can be calculated, and if the measurement of the quality of the audio at certain frequency bands associated with the classes detected by the model can indicate that the audio is over a quality threshold.

In some embodiments, pre-processing can be performed on the received audio being stored in the buffer using an approach for audio event recognition that typically provides less accurate results than the mechanisms used at 130, but that also reduces the use of processor resources. For example, the error rate of such an approach can be higher than the error rate of the mechanisms used at 130. More particularly, the approach used for threshold detection at 330 can result in more false positives than the mechanisms used at 130. In such an embodiment, if the approach used for threshold detection determines a match, this can indicate that the audio signal stored in the buffer may contain an audio event that matches a class detected by a classification model.

If the application determines at 330 that the audio signal received at 110 is over a threshold (“YES” at 330), process 300 can proceed to 340 where some portion of the audio stored in the buffer at 320 (including all of the audio stored in the buffer) can be analyzed using the one or more classification models in accordance with 120 and/or 130 of FIG. 1, and process 300 can proceed to 350.

Otherwise, if the application determines at 330 that the audio signal received at 110 is not over a threshold (“NO” at 330), process 300 can return to 310, where an audio signal can be received and can be stored in the buffer at 320.

At 350, the application can check the results of the analysis at 340 to determine if there is any match between the extracted audio features from the audio signal and a class of the one or more classification models that is greater than a threshold probability (for example, 10%). If there is a match (“YES” at 350), process 300 can proceed to 360. At 360, the application can identify audio events and can generate alerts in accordance with 150 and 160 of FIG. 1, and process 300 can proceed to 370 where an alert can be provided accordance with 170 of FIG. 1 and/or process 200 of FIG. 2.

Otherwise, referring back to 350, if the application determines that a match does not exist (“NO” at 350), process 300 can return to 310 and continue to receive audio signals and store the audio signals in the buffer at 320.

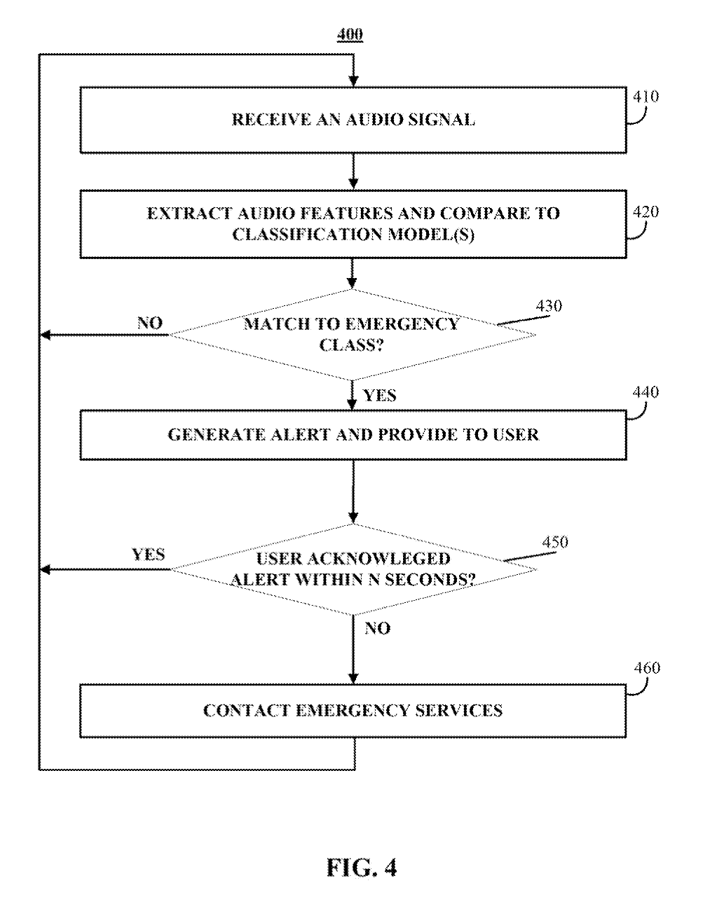

Turning to FIG. 4, a process 400 for contacting emergency services in response to audio event recognition is illustrated in accordance with sonic embodiments of the disclosed subject matter. At 410, process 400 can begin by receiving an audio signal in accordance with examples described with reference to 110 of FIG. 1.

At 420, the application can extract audio features and compare the extracted audio features to one or more classification models in accordance with 120 and 130 of FIG. 1. At 430, the application can determine whether the audio features extracted and compared to the classification models at 420 match any emergency class recognized by the classification models. If the application determines that the audio features extracted at 420 do not match any emergency class recognized by the classification models (“NO” at 430), process 400 can proceed to 410 and continue receiving audio signals. On the other hand, if the application determines that the audio features extracted at 420 match an emergency class recognized by the classification models (“YES” at 430), process 400 can proceed to 440 where an alert can be generated and provided to a user in accordance with 150, 160 and 170 of process 100 and/or process 200, and process 400 can proceed to 450.

In some embodiments, a determination that the audio feature matches an emergency class at 430 can be based on whether the probability of a match with an emergency class exceeds a threshold. For example, if the probability that an audio event matches an emergency class exceeds 50%, 60%, 75%, etc., it can be determined at 430 that there is a match to an emergency class. Additionally or alternatively, it can be determined that an audio event matches an emergency class even if the emergency class is not the most likely match for the audio event. In some instances, the emergency class is determined as a match only if no other class is more likely by a predetermined amount (e.g., no other class is greater than 10% more likely to match the audio event).

At 450, the application can determine whether a user acknowledged the emergency alert within a predetermined period of time (e.g., n seconds, where n can be, for example, five seconds, ten seconds, twenty seconds, etc.). If the application determines that an acknowledgment of the emergency alert was received within the predetermined period of time (“YES” at 450), process 400 can return to 410 and continue to receive audio signals. Otherwise, if the application determines that an acknowledgement of the emergency alert was not received within the predetermined time (“NO” at 450), process 400 can proceed to 460.

At 460, the application can contact emergency services in response to a determination that an acknowledgment of the alert was not received within the predetermined amount of time at 450. In some embodiments, process 400 can use a transceiver and/or other communication device within a mobile device to contact 911, the local fire department, a family member, a private security service, etc. Additionally, in some embodiments, the location of the mobile device and/or the identity of the user and an indication of any disabilities and/or health conditions of the user can be included with the communication from the mobile device. Additionally or alternatively, in some embodiments, the communication from the mobile phone can include any of the following: a text message, an automated pre-recorded telephone call, an automated call based on text generated by the mobile device, a call made using a TTY service or application, an email or other electronic message, any other suitable manner of contacting emergency services, or any suitable combination thereof.

In some embodiments, a failure to receive an acknowledgment of the emergency alert can be indicative of the user being incapable of acknowledging the alert because of an emergency related to the emergency alert. In one example, a deaf person using the mechanisms described herein can be asleep in a building where a fire alarm begins to sound signaling that there may be a fire in or around the building. In such an example, the deaf person cannot hear the fire alarm and, therefore, is not alerted that there may be a fire. The mechanisms described herein can generate an alert indicating to the deaf person that a fire alarm is sounding by vibrating and/or providing a visual alert. If the deaf person does not acknowledge the alert (or if an alert is not otherwise received), the mechanisms can contact emergency services and indicate that the user may be in danger based on the emergency alert.

In some embodiments, the type of emergency services contacted can depend on the nature of the emergency alert generated. For example, for a fire alarm the fire department can be called, for an intrusion detection alarm the police can be called, etc.

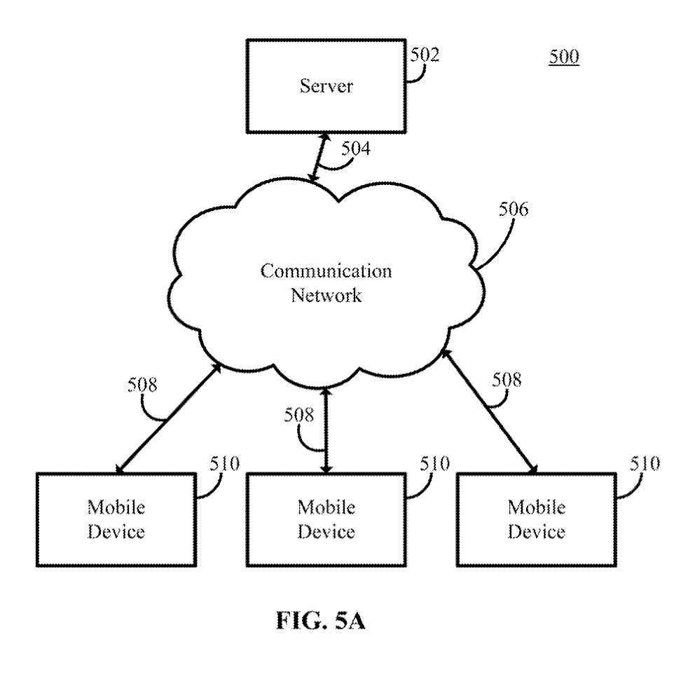

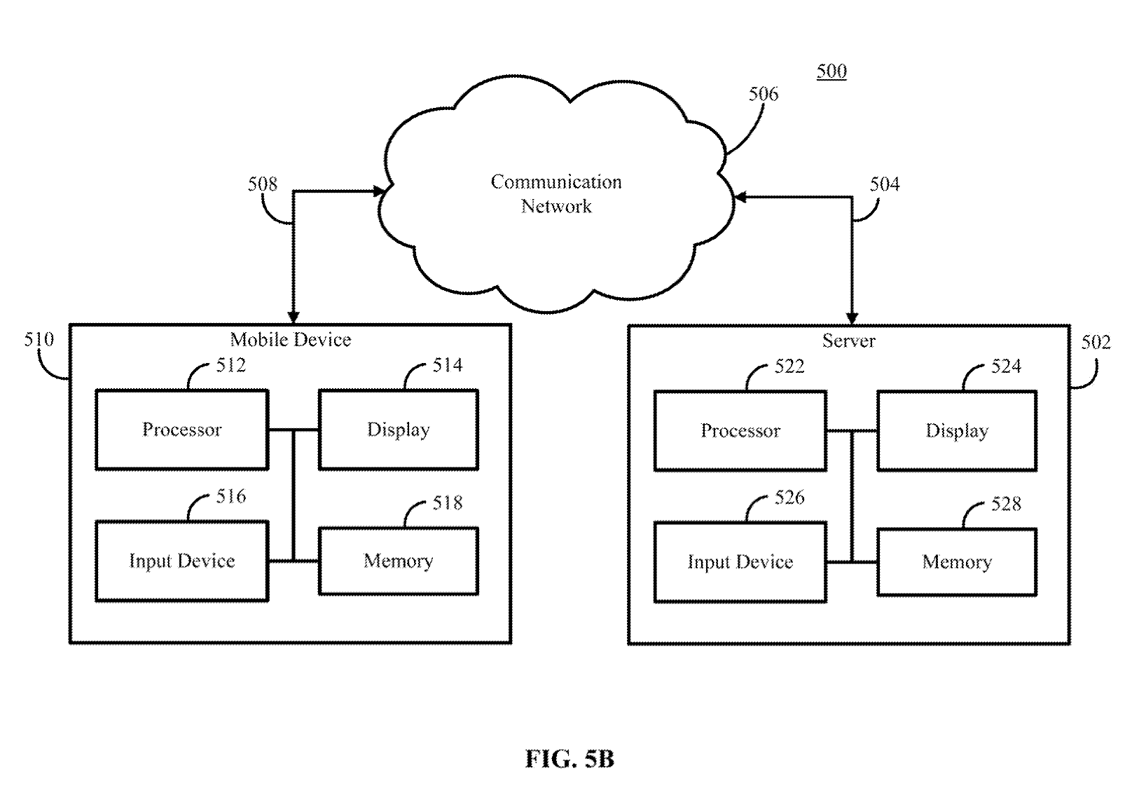

FIG. 5A shows an example of a generalized schematic diagram of a system 500 on which the mechanisms for audio event recognition described herein can be implemented as an application in accordance with some embodiments. As illustrated, system 500 can include one or more mobile devices 510. Mobile devices 510 can be local to each other or remote from each other. Mobile devices 510 can be connected by one or more communications links 508 to a communications network 506 that can be linked via a communications link 506 to a server 502.

System 500 can include one or more servers 502. Server 502 can be any suitable server for providing access to or a copy of the application, such as a processor, a computer, a data processing device, or any suitable combination of such devices. For example, the application can be distributed into multiple backend components and multiple frontend components or interfaces. In a more particular example, backend components, such as data collection and data distribution can be performed on one or more servers 502.

More particularly, for example, each of the mobile devices 510 and server 502 can be any of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. For example, mobile device 510 can be implemented as a smartphone, a tablet computer, a personal data assistant (PDA), a multimedia terminal, a special purpose device, a mobile telephone, a computing device installed in a vehicle, etc.

Referring back to FIG. 5A, communications network 506 can be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any suitable combination of any of such networks. Communications links 504 and 508 can be any communications links suitable for communicating data between mobile devices 510 and server 502, such as network links, dial-up links, wireless links, hard-wired links, any other suitable communications links, or any suitable combination of such links. Mobile devices 510 can enable a user to execute the application that allows the features of the mechanisms to be used. Mobile devices 510 and server 502 can be located at any suitable location.

FIG. 5B illustrates an example of hardware 500 where the server and one of the mobile devices depicted in FIG. 5A are illustrated in more detail. Referring to FIG. 5B, mobile device 510 can include a processor 512, a display 514, an input device 516, and memory 518, which can be interconnected. In some embodiments, memory 518 can include a storage device (such as a computer-readable medium) for storing a computer program for controlling processor 512.

Processor 512 can use the computer program to present on display 514 an interface that allows a user to interact with the application and to send and receive data through communication link 508. It should also be noted that data received through communications link 508 or any other communications links can be received from any suitable source. In some embodiments, processor 512 can send and receive data through communication link 508 or any other communication links using, for example, a transmitter, receiver, transmitter/receiver, transceiver, or any other suitable communication device. Input device 516 can be a computer keyboard, a cursor-controller, dial, switchbank, lever, touchscreen, or any other suitable input device as would be used by a designer of input systems or process control systems.

Server 502 can include processor 522, display 524, input device 526, and memory 528, which can be interconnected. In some embodiments, memory 528 can include a storage device for storing data received through communications link 504 or through other links, and also receives commands and values transmitted by one or more users. The storage device can further include a server program for controlling processor 522.

In one particular embodiment, the application can include client-side software, hardware, or both. For example, the application can encompass a computer program written in a programming language recognizable by the mobile device executing the application (e.g., a program written in a programming language, such as, Java, C, Objective-C, C++, C#, Javascript, Visual Basic, or any other suitable approaches).

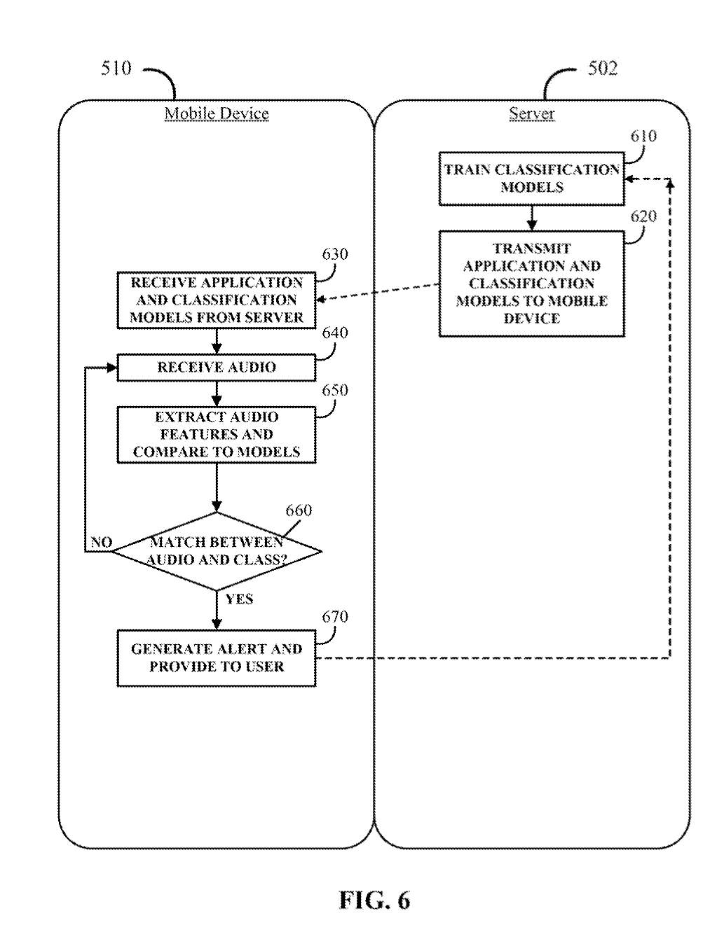

In some embodiments, the application containing a user interface and mechanisms for receiving audio, transmitting audio, providing alerts, and other functions, along with one or more trained classification models can be delivered to mobile device 510 and installed, as illustrated in the example shown in FIG. 6. At 610, one or more classification models can be trained in accordance with the mechanisms described herein. In one example, this can be done by server 502. In another example, the classification models can be trained using any suitable device and can be uploaded to server 502 in any suitable manner. At 620, the classification models trained at 610 can be transmitted to mobile device 510 as part of the application for utilizing the mechanisms described herein. It should be noted that transmitting the application to the mobile device can be done from any suitable device and is not limited to transmission from server 502. It should also be noted that transmitting the application to mobile device 510 can involve intermediate steps, such as, downloading the application to a personal computer or other device, and/or recording the application in memory or storage, such as flash memory, a SIM card, a memory card, or any other suitable device for temporarily or permanently storing an application.

Mobile device 510 can receive the application and classification models from server 502 at 630. After the application is received at mobile device 510, the application can be installed and can begin capturing audio signals at 640 in accordance with 110 of process 100 described herein. The application executing on mobile device 510 can extract audio features from the audio signal and compare the audio features to the classification models at 650 in accordance with 120 and 130 of process 100, determine if there is a match in accordance with 140 of process 100, and generate and output alerts in accordance with 150, 160, and 170 of process 100 and/or process 200. It should be noted that, upon generating an alert in response to a match between the audio features and one or more classification models, the alert and/or labeled audio features corresponding to the alert can be transmitted to server 502. In this embodiment, server 502 can use the labeled audio features to update and/or improve the one or more classification models. For example, the labeled audio features can be used to train one or more classification models. These updated classification models can be transmitted to the application executing on mobile device 510 (e.g., a new version of the application, an update to the application, updated classification models, etc.). For example, updated classification models can be transmitted to the mobile device 510 upon detecting a particular event, such as docking mobile device 510, a particular time, access to a particular type of communications network, etc.

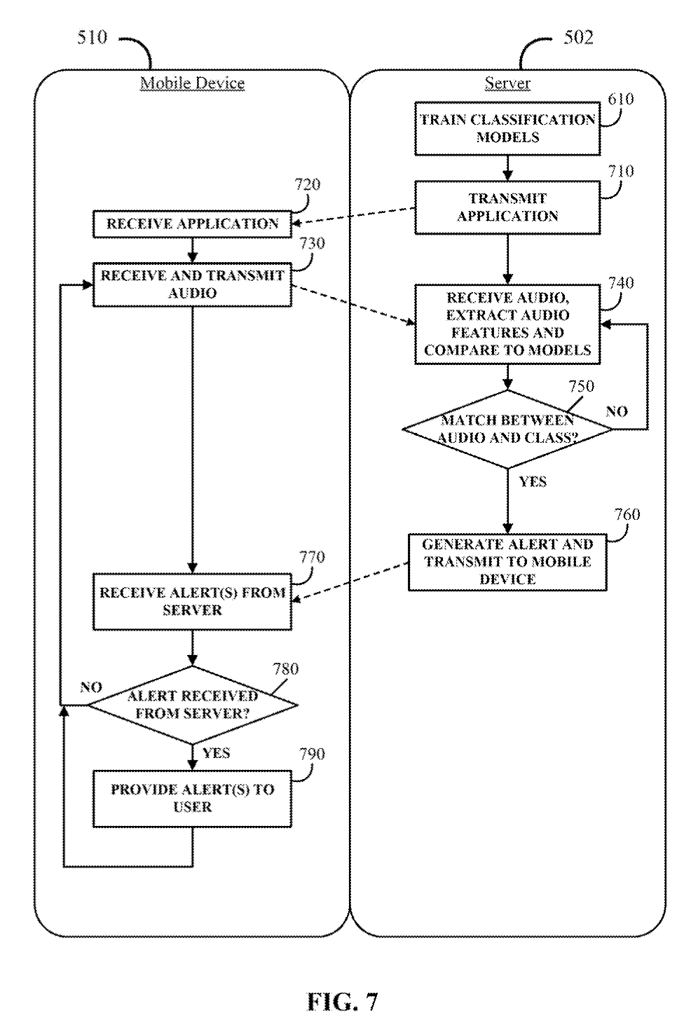

In some embodiments, the application containing a user interface and mechanisms for receiving audio, transmitting audio, providing alerts, and other user interface functions can be transmitted to mobile device 510, but the classification models can be kept on server 502, as illustrated in the example shown in FIG. 7. Similarly to the example in FIG. 6, at 610, one or more classification models can be trained in accordance with the mechanisms described herein. Server 502 can transmit the application to mobile device 510 at 710, and mobile device 510 can receive the application at 720, and start receiving audio and transmitting it to the server 502 at 730. In some embodiments, audio is transmitted to the server in response to some property of the received audio being over a threshold, as described in relation to 330 in FIG. 3. Mobile device 510 can proceed to 770, where mobile device 510 can receive alerts sent from server 502, and proceed to 780.

At 740, server 502 can receive audio from mobile device 510, extract audio features in accordance with 120 of FIG. 1, and compare the extracted audio features to the classification models in accordance with 130 of FIG. 1. Server 502 can determine if there is a match between the extracted and compared audio features at 750 in accordance with 140 of FIG. 1, and if there is a match proceed to 760. If there is not a match at 750, server 502 can return to 740 and continue to receive audio transmitted from mobile device 510.

At 760, server 502 can generate an alert based on the presence of a match between the audio features extracted at 740 and a class of the classification models trained at 610, and transmits the alert to mobile device 510. As described above, after receiving and transmitting audio at 730, mobile device 510 can proceed to 770 where it can receive an alert from the server, and return to 750 to check if an alert has been received from server 502. If an alert has been received (“YES” at 780), mobile device 510 can proceed to 790 where is provides the alert to a user of the mobile device in accordance with 170 of process 100 and/or process 200. If an alert has not been received (“NO” at 750), mobile device 510 can return to 730 where it can continue to receive and transmit audio.

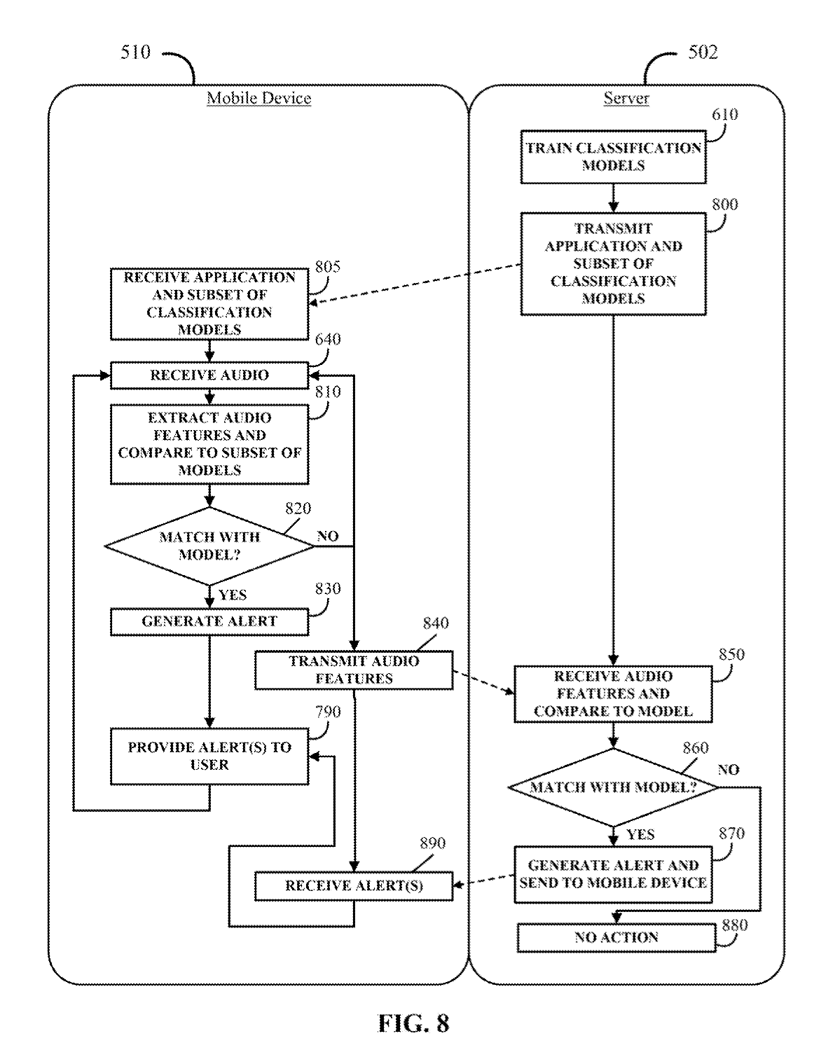

In some embodiments, the application containing a user interface and mechanisms for receiving audio, transmitting audio, providing alerts, other user interface functions, along with a subset of one or more classification models can be transmitted to mobile device 510 and installed, as illustrated in the example shown in FIG. 8. Similarly to the example in FIG. 6, at 610, one or more classification models can be trained in accordance with the mechanisms described herein. Server 502 can transmit the application and a subset of the classification models to mobile device 510 at 805.

Mobile device 510 can receive the application and classification models from server 502 at 805. After the application is received at mobile device 510 it can be installed and can begin capturing audio signals at 640 in accordance with 110 of process 100 described herein. The application executing on mobile device 510 can extract, audio features from the audio signal and compare the audio features to the classification models at 810 in accordance with 120 and 130 of process 100, and determine if there is a match at 820 with the partial model in accordance with 140 of process 100. If there is a match at 820, mobile device 510 can generate alerts at 830 in accordance with 150 and 160, and can output alerts at 790 in accordance with 170 of process 100 and/or process 200. If there is not a match at 820, mobile device 510 can proceed to 840 where the audio features extracted at 810 can be transmitted to server 502.

Server 502 can receive the audio features and compare the audio features to the whole model at 850. At 860, server 502 can determine if there is a match between the audio features received at 850 and the classes recognized by the classification models. If there are no matches at 860 server 502 can proceed to 880 and take no action. If there is a match, server 502 can proceed to 870 where an alert can be generated based on the match and sent to mobile device 510 that transmitted the audio features that generated the alert.

At 890, mobile device 510 can receive any alert generated by server 502 based on the audio features transmitted at 840, and provide the received alert to the user at 790. In some embodiments, a subset of classes can be contained in the subset of classification models sent to the user, which can include common and/or important audio events, such as, telephone ringing, doorbell, door knock, emergency alarms, etc. In some embodiments, the user of mobile device 510 can set the application to send non-recognized audio events to a server for identification, or only attempt to recognize the subset contained in the subset of classification models. This can allow the user to recognize common and/or important sounds using fewer classification models and an application that is less processor intensive because it does not have to compare audio features to as many classification models, while having access to a more complete set of classification models stored on a server, where processor resources can be more plentiful than on a mobile device.

These mechanisms can be used in a variety of applications. For example, a software application that provides these audio event recognition mechanisms can be installed on a mobile device of a user that is deaf or hearing impaired. This can provide such a user with a greater awareness of the ambient sounds encountered in daily life as well as provide protection in emergency situations by generating an alert in connection with indications of danger (e.g., a fire alarm, a car horn, etc.). In addition, this can provide the user with audio event recognition in real-time on a mobile platform.

In some embodiments, any suitable computer readable media can be used fur storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that the above described steps of the processes of FIGS. 1-4 and 6-8 can be executed or performed in any order or sequence not limited to the order and sequence shown and described in the figures. Also, some of the above steps of the processes of FIGS. 1-4 and 6-8 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed:

1. A method for recognizing audio events, the method comprising:
receiving, using a hardware processor in a mobile device, an application that includes a plurality of classification models from as server, wherein each of the plurality of classification models is trained to identify one of a plurality of classes of non-speech audio events;
receiving, using the hardware processor, an audio signal;
storing, using the hardware processor, at least a portion of the audio signal;
extracting, using the hardware processor, a plurality of audio features from the portion of the audio signal based on one or more criterion;
comparing, using the hardware processor, each of the plurality of extracted audio features with the plurality of classification models;
identifying, using the hardware processor, at least one class of non-speech audio events present in the portion of the audio signal based on the comparison; and
providing, using the hardware processor, an alert corresponding to the at least one class of identified non-speech audio events.

2. The method of claim 1, further comprising, classifying the one or more non-speech audio events present in the audio signal based on mel-frequency cepstral coefficient statistics.

3. The method of claim 2, wherein classifying further comprises:
converting the plurality of extracted audio features from a hertz scale to a mel scale;
obtaining mel-frequency cepstral coefficients from the converted audio features in the mel scale; and
using the obtained mel-frequency cepstral coefficients in a hidden Markov model for classifying the one or more non-speech audio events.

4. The method of claim 3, wherein extracting further comprises segmenting the portion of the audio signal into a plurality of frames and wherein converting the extracted audio features further comprises segmenting each of the plurality of frames into a plurality of mel-frequency bands.

5. The method of claim 1, further comprising classifying the one or more non-speech audio events present in the audio signal based on a trained support vector machine.

6. The method of claim 1, further comprising classifying the one or more non-speech audio events present in the audio signal based on a hidden Markov model.

7. The method of claim 1, further comprising classifying the one or more non-speech audio events present in the audio signal based on non-negative matrix factorization.

8. The method of claim 7, wherein classifying further comprises:
concatenating a plurality of training data spectrograms;
performing a convolutive non-negative matrix factorization using the concatenated training data spectrograms to obtain a plurality of basis patches and a plurality of basis activations; and
using the plurality of basis patches and the plurality of basis activations in a hidden Markov model for classifying the one or more non-speech audio events.

9. The method of claim 8, wherein extracting further comprises:
converting the plurality of extracted audio features from a hertz scale to a mel scale;
segmenting the portion of the audio signal into a plurality of frames, were each of the plurality of frames is further segmented into a plurality of mel-frequency bands; and
calculating a short time Fourier transform of each of the plurality of frames.

10. The method of claim 1, further comprising:
identifying a plurality of classes of non-speech audio events present in the portion of the audio signal; and
receiving a user selection of one of the plurality of classes.

11. The method of claim 10, further comprising transmitting the plurality of extracted audio features and the user selection to the server.

12. The method of claim 11, further comprising receiving an updated classification model that was updated based on the user selection.

13. The method of claim 1, wherein the audio signal is received from a microphone at a mobile device.

14. The method of claim 13, wherein the alert includes at least one of a visual alert that is provided on a display of the mobile device and a vibrotactile signal that is caused to be generated by the mobile device.

15. The method of claim 1, wherein the one or more criterion include at least one of: an amplitude of the portion of the audio signal; a frequency of the portion of the audio signal; a quality of the portion of the audio signal; and the amplitude of the portion of the audio signal in one or more frequency bands.

16. A system for recognizing audio events, the system comprising:
a processor of a mobile device that:
receives, using a hardware processor in a mobile device, an application that includes a plurality of classification models from a server, wherein each of the plurality of classification models is trained to identify one of a plurality of classes of non-speech audio events;
receives, using the hardware processor, an audio signal;
stores, using the hardware processor, at least a portion of the audio signal;
extracts, using the hardware processor, a plurality of audio features from the portion of the audio signal based on one or more criterion;
compares, using the hardware processor, each of the plurality of extracted audio features with the plurality of classification models;
identifies, using the hardware processor, at least one class of non-speech audio events present in the portion of the audio signal based on the comparison; and
provides, using the hardware processor, an alert corresponding to the at least one class of identified non-speech audio events.

17. A non-transitory computer-readable medium containing computer-executable instructions that, when executed by a processor, cause the processor to perform a method for recognizing audio events, the method comprising:
receiving an application that includes a plurality of classification models from a server, wherein each of the plurality of classification models is trained to identify one of a plurality of classes of non-speech audio events;
receiving an audio signal;
storing at least a portion of the audio signal;
extracting a plurality of audio features from the portion of the audio signal based on one or more criterion;
comparing each of the plurality of extracted audio features with the plurality of classification models;
identifying at least one class of non-speech audio events present in the portion of the audio signal based on the comparison; and
providing an alert corresponding to the at least one class of identified non-speech audio events.
